(19) United States
(12) Patent Application Publication
(10) Pub. No.: US 2026/0081333 A1
(43) Pub. Date: Mar. 19, 2026

(54) NON-RECIPROCAL CIRCUIT ELEMENT AND QUANTUM COMPUTER

(71) Applicant: TDK CORPORATION, Tokyo (JP)

(72) Inventors: Nobutaka NISHIO, Tokyo (JP); Yoshiaki Sato, Tokyo (JP); Hidenori Ohata, Tokyo (JP); Atsushi Ajioka, Tokyo (JP)

(73) Assignee: TDK CORPORATION, Tokyo (JP)

(21) Appl. No.: 19/298,487

(22) Filed: Aug. 13, 2025

(30) Foreign Application Priority Data
Sep. 19, 2024 (JP) 2024-162210

(51) Int. Cl. H01P 1/36; H01B 1/02; H01B 12/02

(52) U.S. Cl. CPC H01P 1/36; H01B 1/023; H01B 12/02

(57) ABSTRACT

A non-reciprocal circuit element capable of sufficiently suppressing heat generation in a cryogenic environment, and quantum computer equipped with same. The non-reciprocal circuit element includes center conductor, a first and second loss layer disposed outside the center conductor, and a first and second housing disposed outside first and second loss layer. The first loss layer includes first magnetic body and first absorber, and second loss layer includes second magnetic body and second absorber. The center conductor includes a first and second terminal for inputting and outputting a signal, a region that overlaps with the first magnetic body and the second magnetic body as viewed from the thickness direction and extends across the first terminal and the second terminal, and a region that overlaps with the first absorber and the second absorber as viewed from the thickness direction, and non-reciprocally transmits the signal between the first terminal and the second terminal.

### TECHNICAL FIELD

The present invention relates to a non-reciprocal circuit element and a quantum computer.

### BACKGROUND ART

A non-reciprocal circuit element is an element that defines the transmission direction of a high-frequency signal. Examples of the non-reciprocal circuit elements include an isolator and a circulator. The non-reciprocal circuit elements are widely used in circuits in which high-frequency signals are transmitted.

The non-reciprocal circuit elements are used in various places where high-frequency signals are used. For example, Patent Document 1 discloses an isolator with an operating frequency range from a few GHz to about 10 GHz.

Isolators are also used in quantum computers. Among various types of quantum computers, the superconducting quantum computer, which is currently regarded as the most promising, requires isolators that function at cryogenic temperatures in order to enable accurate measurement of quantum bits.

### CITATION LIST

### Patent Document

[Patent Document 1] International Publication WO 2023/238310

### SUMMARY OF THE INVENTION

### Problems to be Solved by the Invention

The isolator is disposed at the location closest to the quantum bit, in the section with the lowest temperature within the refrigerator of the superconducting quantum computer.

The isolator achieves its isolation properties by converting high-frequency signals into heat, so the generation of heat is unavoidable. Therefore, it is necessary to minimize heat generation in the isolator in order to maintain the cryogenic environment around the quantum bit.

The non-reciprocal circuit element disclosed in Patent Document 1, however, is based on the structure of an isolator that functions at room temperature and has the problem of not sufficiently suppressing heat generation in a cryogenic environment.

The present invention has been made in order to solve such conventional problems, and an object of the present invention is to provide a non-reciprocal circuit element capable of sufficiently suppressing heat generation in a cryogenic environment and a quantum computer equipped with the same.

### Means for Solving Problems

The present invention provides the following means to solve the above problems.

A non-reciprocal circuit element according to an embodiment of the present invention includes a conductor, a loss layer disposed outside the conductor, and a housing disposed outside the loss layer. The loss layer includes a magnetic body and an absorber. The conductor has a first terminal and a second terminal for inputting and outputting a signal, a region that overlaps with the magnetic body and extends across the first terminal and the second terminal as viewed from the thickness direction, and a region that overlaps with the absorber as viewed from the thickness direction, and non-reciprocally transmits the signal between the first terminal and the second terminal, At least a part of the conductor is composed of a superconductor.

### Effects of the Invention

The present invention provides a non-reciprocal circuit element capable of sufficiently suppressing heat generation in a cryogenic environment and a quantum computer equipped with the same.

### BRIEF DESCRIPTION OF DRAWINGS

FIG. 1 is a cross-sectional view (Part 1) of a non-reciprocal circuit element according to an embodiment of the present invention.

FIG. 2 is a plan view of the non-reciprocal circuit element according to the embodiment of the present invention.

FIG. 3 is a plan view of a loss layer and a frame of the non-reciprocal circuit element according to the embodiment of the present invention.

FIG. 4 is a plan view of an adhesive layer and the frame of the non-reciprocal circuit element according to the embodiment of the present invention.

FIG. 5 is a cross-sectional view (Part 2) of the non-reciprocal circuit element according to the embodiment of the present invention.

FIG. 6 is a plan view showing the state where the loss layer is divided into a plurality of pieces in the non-reciprocal circuit element according to the embodiment of the present invention.

FIG. 7 is a plan view of a center conductor and a resonator of the non-reciprocal circuit element according to the embodiment of the present invention.

FIG. 8 is a plan view of a housing and a magnet of the non-reciprocal circuit element according to the embodiment of the present invention.

FIG. 9 is a table showing the physical properties of various materials.

FIG. 10 is a schematic diagram of a quantum computer according to the embodiment of the present invention.

### DETAILED DESCRIPTION OF EMBODIMENTS

Hereinafter, embodiments of a non-reciprocal circuit element and a quantum computer according to the present invention will be described with reference to the drawings. It should be noted that the dimensional ratio of each component in each drawing does not necessarily correspond to the actual dimensional ratio.

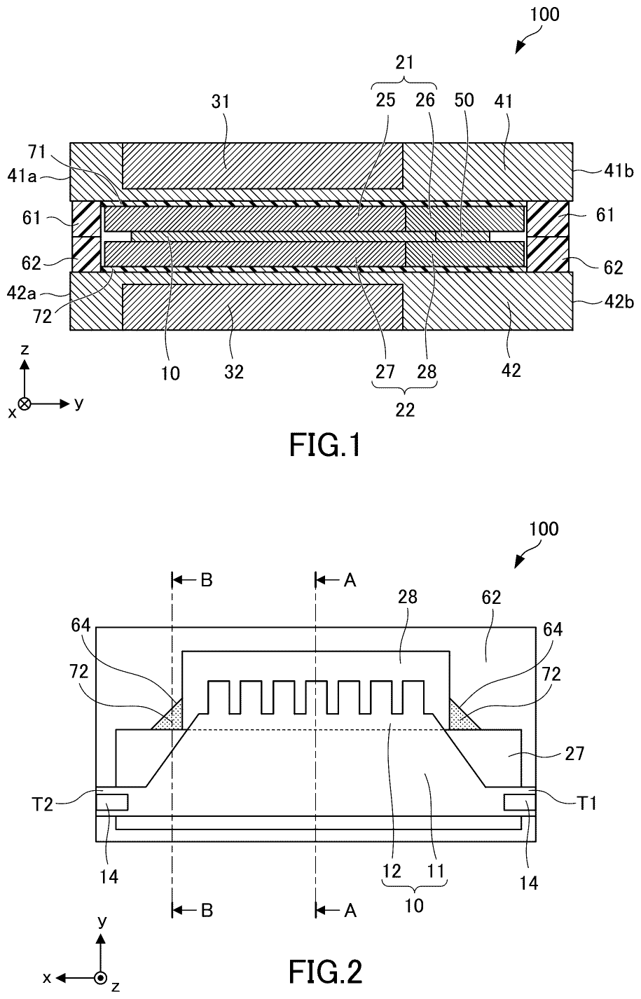

FIG. 1 is a cross-sectional view of a non-reciprocal circuit element 100 according to the embodiment. The non-reciprocal circuit element 100 includes, for example, a center conductor 10, a first loss layer 21, a second loss layer 22, a first magnet 31, a second magnet 32, an upper housing 41 as a first housing, a lower housing 42 as a second housing, a resonator 50, a first frame 61, and a second frame 62. The non-reciprocal circuit element 100 functions as an isolator, for example.

FIG. 2 is a plan view of the non-reciprocal circuit element 100 according to the embodiment. In this specification, the direction from a first terminal T1 to a second terminal T2 of the center conductor 10 is referred to as the x direction, the direction perpendicular to the x direction on the plane where the center conductor 10 extends is referred to as the y direction, and the direction perpendicular to the x direction and the y direction are referred to as the z direction. The thickness direction of each layer is an example of the z direction. Regarding the z direction, the side where the upper housing 41 exists is defined as the upper side, and the side where the lower housing 42 exists is defined as the lower side.

FIG. 2 is a plan view of the center conductor 10, the second loss layer 22, and the second frame 62 from the upper side, excluding the first loss layer 21, the first magnet 31, the upper housing 41, and the lower housing 42 from the non-reciprocal circuit element 100. FIG. 1 is a cross-sectional view showing a section taken along line A-A in FIG. 2.

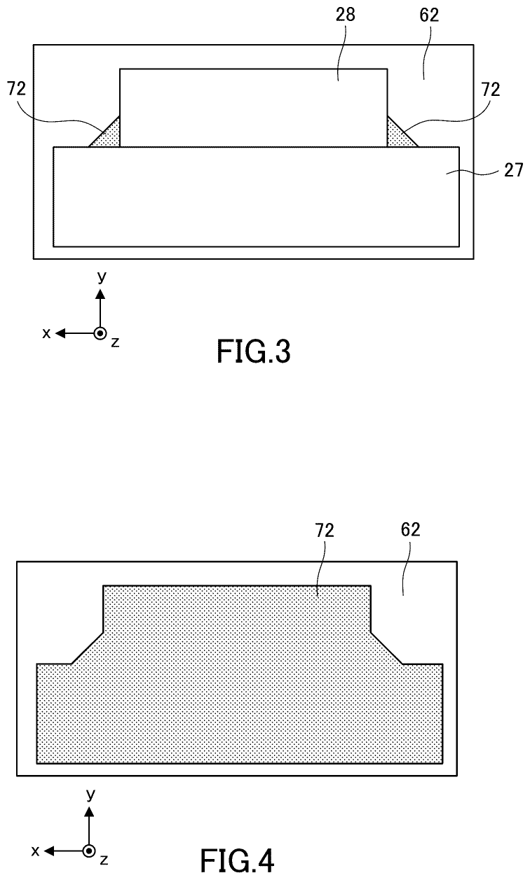

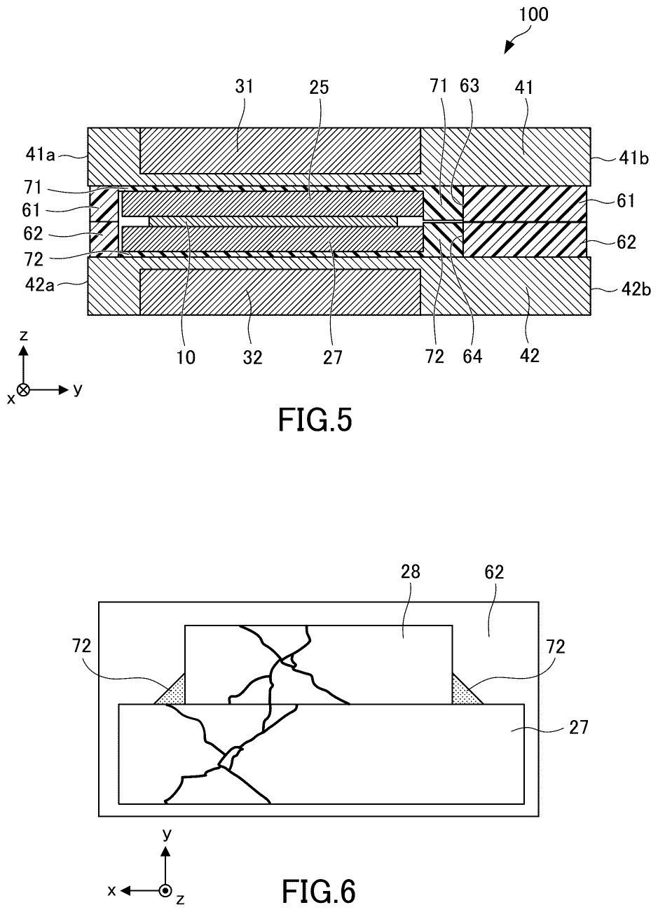

FIG. 3 is a plan view of the second loss layer 22 and the second frame 62 from the upper side, further excluding the center conductor 10 from FIG. 2. FIG. 4 is a plan view of a second adhesive layer 72 and the second frame 62 described below from the upper side, further excluding the second loss layer 22 from FIG. 3. FIG. 5 is a cross-sectional view showing a section taken along line B-B in FIG. 2.

The first loss layer 21 and the second loss layer 22 are disposed outside the center conductor 10 and the resonator 50, respectively, so as to sandwich the center conductor 10 and the resonator 50 in the z direction. The first loss layer 21 includes a first magnetic body 25 and a first absorber 26. The second loss layer 22 includes a second magnetic body 27 and a second absorber 28. The shapes of the first loss layer 21 and the second loss layer 22 are substantially identical and symmetrical with respect to the center conductor 10 and the resonator 50. The first loss layer 21 is located between the center conductor 10 and the first magnet 31. The second loss layer 22 is located between the center conductor 10 and the second magnet 32.

The upper housing 41 and the lower housing 42 are disposed outside the first loss layer 21 and the second loss layer 22, respectively, so as to sandwich the first loss layer 21 and the second loss layer 22 in the z direction. The upper housing 41 is sandwiched between the first magnet 31 and the first loss layer 21. The lower housing 42 is sandwiched between the second magnet 32 and the second loss layer 22. The upper housing 41 or the lower housing 42 is conductive, and is grounded to a reference potential, for example. The reference potential is, for example, ground.

As shown in FIG. 1 and the like, the upper housing 41 includes heat dissipation surfaces 41a, 41b, which dissipate heat generated in the center conductor 10, the first loss layer 21, and the second loss layer 22. Similarly, the lower housing 42 includes heat dissipation surfaces 42a, 42b, which dissipate heat generated in the center conductor 10, the first loss layer 21, and the second loss layer 22. The heat dissipation surfaces 41a, 41b, 42a, 42b are surfaces parallel to the xz plane.

The upper housing 41 is attached to a cryogenic plate that serves as a heat bath in a refrigerator (not shown), through the heat dissipation surfaces 41a, 41b. Similarly, the lower housing 42 is attached to a cryogenic plate in a refrigerator (not shown), through the heat dissipation surfaces 42a, 42b.

The upper housing 41 and the lower housing 42 include a high thermal conductivity material with a thermal conductivity of 300 W/m. K or more at cryogenic temperatures of 4K or lower. The high thermal conductivity material constituting the upper housing 41 and the lower housing 42 is, for example, one of metals such as gold (Au), silver (Ag), copper (Cu), platinum (Pt), palladium (Pd), indium (In), or aluminum (Al).

By configuring the upper housing 41 and the lower housing 42 in this manner, the non-reciprocal circuit element 100 can maintain thermal conductivity at cryogenic temperatures, thereby improving heat dissipation and reducing Johnson noise (thermal noise). Therefore, the non-reciprocal circuit element 100 contributes to accurate measurement of quantum bits when used in a quantum computer because of improved insertion loss.

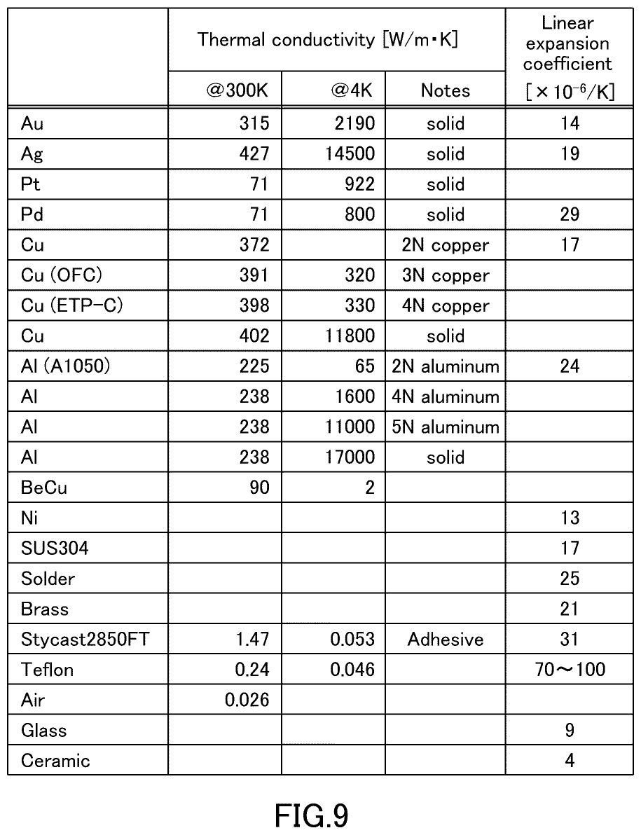

In particular, it is preferable to use copper with a purity of 4N (99.99%) or higher as the high thermal conductivity material comprising the upper housing 41 and the lower housing 42, since it can effectively increase thermal conductivity at cryogenic temperatures. As shown in FIG. 9, copper with a purity of 4N exhibits a thermal conductivity of 330 W/m·K at 4K. Furthermore, copper with a purity higher than 4N and almost 100% exhibits a thermal conductivity of 11800 W/m·K at 4K. In FIG. 9, “solid” means almost 100% purity.

The upper housing 41 and the first loss layer 21 are bonded by a first adhesive layer 71 consisting of an insulating adhesive. Similarly, the lower housing 42 and the second loss layer 22 are bonded by the second adhesive layer 72 consisting of an insulating adhesive. Only one of the pair of the upper housing 41 and the first loss layer 21, or the pair of the lower housing 42 and the second loss layer 22, may be bonded by the first adhesive layer 71 or the second adhesive layer 72.

As shown in FIG. 6, at least one of the first loss layer 21 and the second loss layer 22 may be divided into a plurality of pieces due to impact or thermal expansion and contraction. In such a case, the first adhesive layer 71 or the second adhesive layer 72 can hold the plurality of pieces in place to prevent them from falling out from between the upper housing 41 and the lower housing 42.

Accordingly, even if at least one of the first loss layer 21 and the second loss layer 22 cracks irregularly, the non-reciprocal circuit element 100 can maintain the isolation properties of the non-reciprocal circuit element 100.

The first adhesive layer 71 and the second adhesive layer 72 have a linear expansion coefficient of 35×10⁻⁶/K or less at cryogenic temperatures of 4K or lower. For example, STYCAST 2850 FT or STYCAST 2850GT, manufactured by Henkel, can be suitably used as the first adhesive layer 71 and the second adhesive layer 72. As shown in FIG. 9, the linear expansion coefficient of STYCAST 2850 FT is 31×10⁻⁶/K and the linear expansion coefficient of STYCAST 2850GT is 25×10⁻⁶/K, both of which is particularly close to the linear expansion coefficients of metals such as aluminum (Al), copper, solder, and brass.

The first adhesive layer 71 and the second adhesive layer 72, which have a linear expansion coefficient similar to that of metal, are less likely to cause film delamination from the upper housing 41 and the lower housing 42, and have excellent adhesion to the upper housing 41 and the lower housing 42.

As shown in FIG. 9, the thermal conductivity of STYCAST 2850 FT is 0.053 W/m. K at 4K, the thermal conductivity of STYCAST 2850GT is 0.1 W/m·K at 4K, both of which are higher than the thermal conductivity of air or vacuum. In contrast, the thermal conductivity of air is 0.026 W/m. K at 300K, and at 4K, it is known to decrease further to about 1/10 of the thermal conductivity of STYCAST 2850 FT at 4K. The thermal conductivity of vacuum is 0.002 W/m·K at 300 K and is nearly zero at 4 K. The internal environment of the refrigerator is a high vacuum.

Therefore, the first adhesive layer 71 and the second adhesive layer 72 consisting of resin-based adhesives such as STYCAST 2850 FT, are capable of maintaining higher thermal conductivity than air at cryogenic temperatures of 4K or lower without reducing adhesion at the interfaces with the upper housing 41, the lower housing 42, the first loss layer 21, and the second loss layer 22, thereby improving the heat dissipation of the non-reciprocal circuit element 100.

The first frame 61 and the second frame 62 are insulating frames provided between the upper housing 41 and the lower housing 42, surrounding the first loss layer 21 and the second loss layer 22, respectively. Teflon (registered trademark), for example, can be suitably used for the first frame 61 and the second frame 62.

As shown in FIG. 5, a gap 63 is formed between the first frame 61 and the first loss layer 21 to store the excess adhesive generated when the upper housing 41 and the first loss layer 21 are bonded by the first adhesive layer 71. In other words, the first adhesive layer 71 is formed extending up to the space between the first frame 61 and the first loss layer 21. Similarly, a gap 64 is formed between the second frame 62 and the second loss layer 22 to store the excess adhesive generated when the lower housing 42 and the second loss layer 22 are bonded by the second adhesive layer 72. In other words, the second adhesive layer 72 is formed extending up to the space between the second frame 62 and the second loss layer 22.

The surface tension of the first adhesive layer 71 stored in the gap 63 prevents the first adhesive layer 71 from entering between the opposing surfaces of the first frame 61 and the first magnetic body 25 along the z direction, between the opposing surfaces of the first frame 61 and the first absorber 26 along the z direction, and between the opposing surfaces of the first magnetic body 25 and the first absorber 26 along the z direction, except in the gap 63.

Similarly, the surface tension of the second adhesive layer 72 stored in the gap 64 prevents the second adhesive layer 72 from entering between the opposing surfaces of the second frame 62 and the second magnetic body 27 along the z direction, between the opposing surfaces of the second frame 62 and the second absorber 28 along the z direction, and between the opposing surfaces of the second magnetic body 27 and the second absorber 28 along the z direction, except in the gap 64.

Therefore, by storing the first adhesive layer 71 and the second adhesive layer 72 in the gaps 63, 64, the first magnetic body 25 and the first absorber 26, as well as the second magnetic body 27 and the second absorber 28, are brought into close contact with each other, thereby stabilizing the isolation properties of the non-reciprocal circuit element 100.

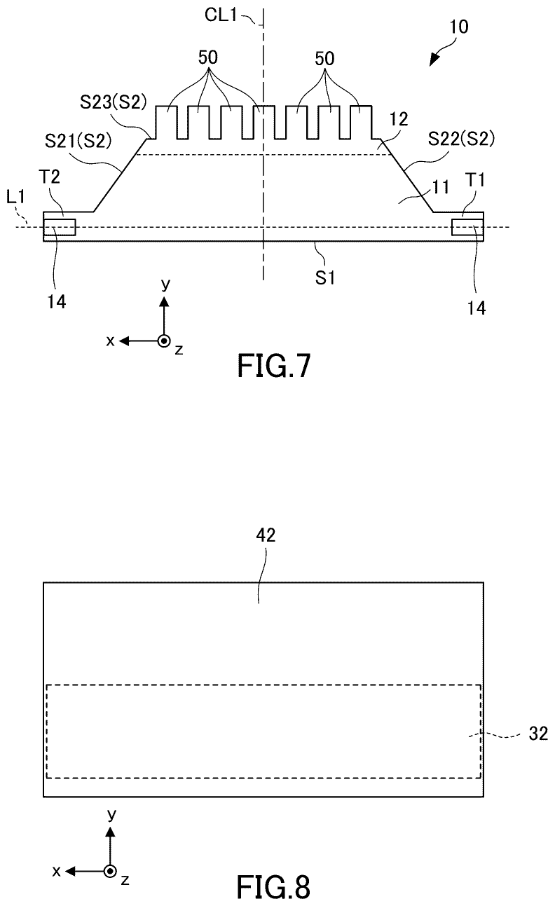

FIG. 7 is a plan view of the center conductor 10 and the resonator 50 of the non-reciprocal circuit element 100 according to the embodiment.

The center conductor 10 has the first terminal T1 and the second terminal T2 for inputting and outputting high-frequency signals. The first terminal T1 and the second terminal T2 are connected to external terminals.

The surfaces of the first terminal T1 and the second terminal T2 may be covered with a metal film made of one of metals such as nickel (Ni), tin, copper, or silver. For example, by plating these metals onto the surfaces of the first terminal T1 and the second terminal T2 to form a metal film 14, it is possible to ensure wettability, connection strength, and conductivity when the first terminal T1 and the second terminal T2 are soldered to external terminals.

The center conductor 10 transmits high-frequency signals non-reciprocally between the first terminal T1 and the second terminal T2. “Transmitting high-frequency signals non-reciprocally” means that the signal propagation efficiency varies depending on the direction. For example, if the center conductor 10 propagates a signal with low loss in the forward direction but hardly propagates a signal in the reverse direction, this would correspond to “transmitting high-frequency signals non-reciprocally”. The propagation direction of the high-frequency signal in the center conductor 10 is controlled by the first loss layer 21 and the second loss layer 22.

The high-frequency signal input from the first terminal T1 is transmitted to the second terminal T2 with low loss. Most of the high-frequency signal input from the second terminal T2 is absorbed by the first absorber 26 and the second absorber 28. In other words, almost no high-frequency signal is transmitted from the second terminal T2 to the first terminal T1.

The center conductor 10 only needs to efficiently transmit high-frequency signals and may be made of metals such as aluminum, copper, silver, gold, stainless steel (SUS), or beryllium copper (BeCu), for example. The center conductor 10 may be a non-conductor or a high-resistance conductor (for example, phosphor bronze) plated with aluminum, copper, silver, gold, stainless steel, or the like.

Alternatively, the center conductor 10 may be a superconductor that exhibits superconductivity at cryogenic temperatures of 4K or lower, such as aluminum, niobium (Nb), tantalum (Ta), or the like. The center conductor 10 may be a non-conductor or a high-resistance conductor (for example, phosphor bronze) plated with a superconductor such as aluminum, niobium, or tantalum.

In particular, it is preferable to use aluminum with a purity of 4N (99.99%) or higher as the superconductor configuring the center conductor 10, since this not only reduces residual resistance but also increases thermal conductivity. As shown in FIG. 9, aluminum with a purity of 4N exhibits a thermal conductivity of 1600 W/m·K at 4K. Aluminum with a purity of 5N exhibits a thermal conductivity of 11000 W/m·K at 4K. Furthermore, aluminum with a purity higher than 5N and almost 100% exhibits a thermal conductivity of 17000 W/m·K at 4K.

The center conductor 10, at least a part of which is composed of a superconductor, exhibits almost zero resistance at cryogenic temperatures and heat generation is suppressed, so that the non-reciprocal circuit element 100 can reduce Johnson noise (thermal noise). Therefore, the non-reciprocal circuit element 100 contributes to accurate measurement of quantum bits when used in a quantum computer because of improved insertion loss.

The center conductor 10 includes a first region 11 and a second region 12. The center conductor 10 may have regions other than the first region 11 and the second region 12. The first region 11 is a region that overlaps with the first magnetic body 25 and the second magnetic body 27, as viewed from the z direction. The first region 11 extends across the first terminal T1 and the second terminal T2. The first region 11 is sandwiched between the first magnetic body 25 and the second magnetic body 27 in the z direction. The second region 12 is a region that overlaps with the first absorber 26 and the second absorber 28, as viewed from the z direction. The second region 12 is sandwiched between the first absorber 26 and the second absorber 28 in the z direction. The boundary between the first region 11 and the second region 12, for example, coincides with the boundary between the first magnetic body 25 and the first absorber 26 as viewed from the z direction.

As shown in FIG. 7, the center conductor 10 has a first connection line S1 and a second connection line S2 on its outer periphery as viewed from the z direction. The first connection line S1 and the second connection line S2 are lines connecting the first terminal T1 and the second terminal T2, respectively. The first connecting line S1 and the second connecting line S2 together form the outer periphery of the center conductor 10 as viewed from the z direction.

The first connection line S1 is one side of the first region 11. The first connection line S1 may be a straight line or a curved line. In the example shown in FIG. 7, the first connection line S1 is a straight line that is parallel to the straight line L1 connecting the first terminal T1 and the second terminal T2.

The second connection line S2 exists across the first region 11 and the second region 12. The second connection line S2, for example, includes a first side S21 and a second side S22 that extend from the first region 11 to the second region 12, and a third side S23, which is one side of the second region 12. The first side S21, the second side S22, and the third side S23 may be straight lines or curved lines.

The resonator 50 confines a portion of the high-frequency signal propagating along the second connection line S2 within a certain space. The resonator 50 is located within the reach of the high-frequency signal propagating along the second connection line S2. The resonator 50 is connected to the center conductor 10, for example. The resonator 50 and the center conductor 10 may be integrated. The resonator 50 is, for example, one or more convex portions protruding from the third side S23.

The resonator 50 shown in FIG. 7 is a quarter-wavelength resonator. The quarter-wavelength resonator satisfies the relationship in Equation (1) below.

$$L \leq 1 / 4 {{f}_{0} ( {ε}_{0} {μ}_{0} {ε}_{γ} {μ}_{γ} )}^{1 / 2} \qquad ( 1 )$$

In Equation (1), L is the length of the quarter-wavelength resonator, f₀ is the resonant frequency, co is the permittivity of the vacuum, μ₀ is the magnetic permeability of the vacuum, Ey is the permittivity of the first absorber 26 and the second absorber 28, and μ_{γ} is the magnetic permeability of the first absorber 26 and the second absorber 28. When the length L of the resonator 50 satisfies an integral multiple of the quarter wavelength of the high-frequency wave propagating along the second connection line S2, the resonator 50 confines the high-frequency signal. The length L is the length of the resonator 50 in the protruding direction from the third side S23.

The resonator 50 overlaps with the first absorber 26 and the second absorber 28, as viewed from the z direction. The resonator 50 is sandwiched between the first absorber 26 and the second absorber 28 in the z direction.

The resonator 50 is made of a conductor. For example, the same material as the center conductor 10 can be used for the resonator 50.

The resonator 50 shown in FIG. 7 is, for example, symmetrical in the x direction with respect to the center line CL1. The center line CL1 is a line that passes through the midpoint of the straight line connecting the first terminal T1 and the second terminal T2, and is perpendicular to the straight line. The resonator 50 symmetrical with respect to the center line CL1 is easy to form, and the resonator 50 symmetrical with respect to the center line CL1 offers excellent versatility.

The first magnetic body 25 and the first absorber 26 are located at different positions in the xy plane, as viewed from the z direction. Similarly, the second magnetic body 27 and the second absorber 28 are located at different positions in the xy plane, as viewed from the z direction. The first magnetic body 25 and the second magnetic body 27 are located to overlap with the first region 11 of the center conductor 10 in the z direction. The first magnetic body 25 and the second magnetic body 27 sandwich the first region 11 in the z direction. The first absorber 26 and the second absorber 28 are located at positions that overlap with the second region 12 of the center conductor 10 and the resonator 50 in the z direction. The first absorber 26 and the second absorber 28 sandwich the second region 12 and the resonator 50 in the z direction.

The first magnetic body 25 and the second magnetic body 27 may have any shape, as long as they can cover the first region 11. The first absorber 26 and the second absorber 28 may have any shape, as long as they can cover the second region 12 and the resonator 50. For example, as shown in FIG. 3, both the first magnetic body 25 and the first absorber 26 may have a rectangular shape as viewed from the z direction.

The high-frequency signal passing through the center conductor 10 propagates while being deviated to one side in the traveling direction due to the application of a DC magnetic field to the first magnetic body 25 and the second magnetic body 27. For example, the high-frequency signal input from the first terminal T1 is deviated to the vicinity of the first connection line S1 and propagates along the first connection line S1 to the second terminal T2. On the other hand, the high-frequency signal input to the second terminal T2 is deviated to the vicinity of the second connection line S2 and propagates along the second connection line S2 to the first terminal T1. At this time, the high-frequency signal input to the second terminal T2 is absorbed by the first absorber 26 and the second absorber 28, resulting in significant attenuation. Furthermore, the high-frequency signal input to the second terminal T2 is trapped by the resonator 50, and the intensity of the high-frequency signal trapped by the resonator 50 is greatly attenuated. Furthermore, the high-frequency signal input to the second terminal T2 is trapped by the resonator 50, and the intensity of the high-frequency signal trapped by the resonator 50 is greatly attenuated.

The first magnetic body 25 and the second magnetic body 27 include a magnetic material. The first magnetic body 25 and the second magnetic body 27 may be conductors or insulators. The first magnetic body 25 and the second magnetic body 27 have, for example, soft magnetic materials. The first magnetic body 25 and the second magnetic body 27 include, for example, any of the materials selected from the group consisting of Co-based amorphous, ferrite, Fe₈₅Si₂B₈P₄Cu, Fe₈₆AlB₈P₄Cu, Fe₇₈Si₉B₁₃, and yttrium-iron-garnet (YIG). YIG is, for example, Y₃Fe₂(FeO₄)₃ or Y₃Fe₅O₁₂.

The first magnetic body 25 and the second magnetic body 27 may be a mixture of magnetic particles and resin. Examples of magnetic particles include iron, silicon steel (Fe—Si), permalloy (Ni—Fe), permendur (Fe—Co), sendust (Fe—Si—Al), electromagnetic stainless steel, amorphous iron-based alloys (Fe—B—C system, Fe—Co system), manganese zinc ferrite, nickel zinc ferrite and the like. The first magnetic body 25 and the second magnetic body 27 may be a mixture of ferrite particles and resin.

When dispersing the magnetic material in an insulating material (e.g., resin, rubber, paint, etc.), it is preferable for the volume ratio of the magnetic material to be 10% or more and 70% or less. If the volume ratio of the magnetic material is low, the electromagnetic wave absorption capability decreases. If the volume ratio of the magnetic material is high, dispersion into the insulating material becomes difficult.

The first absorber 26 and the second absorber 28 include a material with a higher magnetic field loss rate than the first magnetic body 25 and the second magnetic body 27. The first absorber 26 and the second absorber 28 include, for example, any of the materials selected from the group consisting of iron, BN, conductive carbon, SiC, and Ni-based ferrite.

When the first loss layer 21 and the second loss layer 22 are conductors, an insulating layer is provided between the first loss layer 21 and the center conductor 10, and between the second loss layer 22 and the center conductor 10. The insulating layer can be made of a known material.

The first magnet 31 and the second magnet 32 sandwich the center conductor 10, the first loss layer 21, and the second loss layer 22 in the z direction. The first magnet 31 and the center conductor 10 sandwich the first loss layer 21 in the z direction. The second magnet 32 and the center conductor 10 sandwich the second loss layer 22 in the z direction. The first magnet 31 and the second magnet 32 apply a DC magnetic field across the first magnetic body 25 and the second magnetic body 27.

FIG. 8 is a plan view of the lower housing 42 and the second magnet 32 from the upper side. The first magnet 31 and the second magnet 32 are located to overlap with the first magnetic body 25 and the second magnetic body 27, as viewed from the z direction. A portion of the first magnet 31 and the second magnet 32 may overlap with the first absorber 26 and the second absorber 28, as viewed from the z direction.

The first magnet 31 and the second magnet 32 are, for example, made of a hard magnetic material. The first magnet 31 and the second magnet 32 may be insulators or conductors. The first magnet 31 and the second magnet 32 include, for example, any of the materials selected from the group consisting of insulating ferrite magnets, conductive rare earth magnets, TbFeCo, GdFeCo, SmFeCo, [Co/Pt] multilayer films, and [Co/Pd] multilayer films. When the first magnet 31 and the second magnet 32 are conductors, the upper housing 41 and the lower housing 42 may be omitted.

The first magnet 31 and the second magnet 32 are examples of magnetic field sources. The magnetic field source is not limited to the first magnet 31 and the second magnet 32, as long as the magnetic field source can apply a DC magnetic field to the first magnetic body 25 and the second magnetic body 27 through the upper housing 41 and the lower housing 42, respectively.

The non-reciprocal circuit element 100 according to the embodiment achieves excellent isolation properties by including the resonator 50. The resonator 50 confines, within the resonator 50, a part of the high-frequency signal input from the second terminal T2, and prevents the high-frequency signal input from the second terminal T2 from reaching the first terminal T1. The lower the intensity of the high-frequency signal reaching the first terminal T1 from the second terminal T2, the higher the isolation properties of the non-reciprocal circuit element 100.

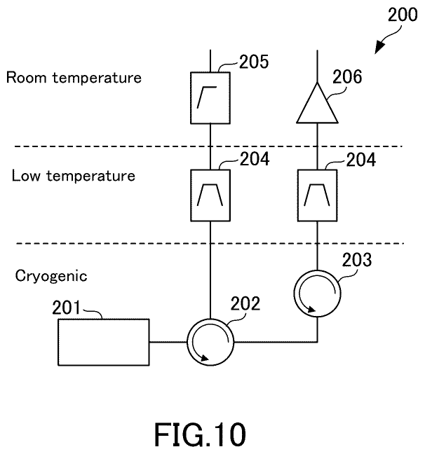

The non-reciprocal circuit element 100 according to the embodiment can be applied to, for example, a quantum computer. FIG. 10 is a schematic diagram of a quantum computer according to the embodiment. The quantum computer 200 includes, for example, a quantum processor 201, non-reciprocal circuit elements 202, 203, filters 204, 205, and an amplifier 206.

The quantum processor 201 performs quantum computation. The non-reciprocal circuit elements 202, 203 distribute a readout signal of a quantum bit from the quantum processor 201. The non-reciprocal circuit element 202 is a circulator. The non-reciprocal circuit element 203 is an isolator. The non-reciprocal circuit element 100 according to the embodiment can be applied to the non-reciprocal circuit element 203. The amplifier 206 amplifies the readout signal.

For example, a superconducting quantum computer operates at cryogenic temperatures. Therefore, the quantum processor 201 and the non-reciprocal circuit elements 202, 203 are also disposed in positions exposed to a cryogenic environment. It is difficult to maintain a large volume of space in the cryogenic environment, and it is therefore necessary to miniaturize the non-reciprocal circuit elements 202, 203. The non-reciprocal circuit element 100 according to the embodiment is compact and has excellent heat dissipation properties, and therefore can realize high performance and stable operation of the quantum computer.

### DESCRIPTION OF REFERENCES

10 Center conductor
11 First region
12 Second region
14 Metal film
21 First loss layer
22 Second loss layer
25 First magnetic body
26 First absorber
27 Second magnetic body
28 Second absorber
31 First magnet
32 Second magnet
41 Upper housing
41a, 41b Heat dissipation surface
42 Lower housing
42a, 42b Heat dissipation surface
50 Resonator
61 First frame
62 Second frame
63, 64 Gap
71 First adhesive layer
72 Second adhesive layer
100 Non-reciprocal circuit element
200 Quantum computer
201 Quantum processor
202, 203 Non-reciprocal circuit element
204, 205 Filter
206 Amplifier
S1 First connection line
S2 Second connection line
S21 First side
S22 Second side
S23 Third side
T1 First terminal
T2 Second terminal

What is claimed is:

1. A non-reciprocal circuit element, comprising:
a conductor;
a loss layer disposed outside the conductor; and
a housing disposed outside the loss layer, wherein
the loss layer includes a magnetic body and an absorber,
the conductor includes a first terminal and a second terminal for inputting and outputting a signal, a first region that overlaps with the magnetic body as viewed from the thickness direction and extends across the first terminal and the second terminal, and a second region that overlaps with the absorber as viewed from the thickness direction, and non-reciprocally transmits the signal between the first terminal and the second terminal, and
at least a part of the conductor is composed of a superconductor.

2. The non-reciprocal circuit element according to claim 1, wherein
the superconductor is any of aluminum, niobium, or tantalum.

3. The non-reciprocal circuit element according to claim 1, wherein
the superconductor is aluminum with a purity of 99.99% or higher.

4. The non-reciprocal circuit element according to claim 1, wherein
the conductor is a phosphor bronze member plated with aluminum, niobium, or tantalum.

5. The non-reciprocal circuit element according to claim 1, wherein
a metal film is provided on each surface of the first terminal and the second terminal.

6. The non-reciprocal circuit element according to claim 5, wherein
the metal film is any of nickel, tin, copper, or silver.

7. The non-reciprocal circuit element according to claim 1, wherein
the housing includes a high thermal conductivity material having a heat-conductivity of 300 W/m·K or more at cryogenic temperatures.

8. The non-reciprocal circuit element according to claim 7, wherein
the high thermal conductivity material is any of gold, silver, copper, platinum, palladium, indium, or aluminum.

9. The non-reciprocal circuit element according to claim 7, wherein
the high thermal conductivity material is copper with a purity of 99.99% or higher.

10. The non-reciprocal circuit element according to claim 1, wherein
the housing is grounded to a reference potential.

11. The non-reciprocal circuit element according to claim 1, wherein
the housing has a heat dissipation surface that dissipates heat generated in the conductor and the loss layer.

12. The non-reciprocal circuit element according to claim 11, wherein
the housing is attached to a cryogenic plate that serves as a heat bath in a refrigerator, through the heat dissipation surface.

13. The non-reciprocal circuit element according to claim 1, further comprising a resonator that overlaps with the absorber as viewed from the thickness direction,

14. The non-reciprocal circuit element according to claim 13, wherein
the resonator is one or more convex portions protruding from a side of the second region of the conductor.

15. The non-reciprocal circuit element according to claim 13, wherein
the resonator is connected to the conductor.

16. The non-reciprocal circuit element according to claim 13, wherein
the resonator is symmetrical with respect to a center line that is a line that passes through the midpoint of a straight line connecting the first terminal and the second terminal and is perpendicular to the straight line.

17. The non-reciprocal circuit element according to claim 13, wherein
the resonator is a quarter-wavelength resonator.

18. The non-reciprocal circuit element according to claim 17, wherein
the quarter-wavelength resonator satisfies the relationship in Equation (1):
$$L \leq 1 / 4 {{f}_{0} ( {ε}_{0} {μ}_{0} {ε}_{γ} {μ}_{γ} )}^{1 / 2} \qquad ( 1 )$$
where, in Equation (1), L is the length of the quarter-wavelength resonator, f₀ is the resonant frequency, ε₀ is the permittivity of the vacuum, μ₀ is the magnetic permeability of the vacuum, ε_{γ} is the permittivity of the absorber, and μ_{γ} is the magnetic permeability of the absorber.

19. A quantum computer comprising the non-reciprocal circuit element according to claim 1.

20. The quantum computer according to claim 19 wherein
the non-reciprocal circuit element is an isolator.
